(19) United States
(12) Patent Application Publication
(10) Pub. No.: US 2009/0265391 A1
(43) Pub. Date: Oct. 22, 2009

(54) APPARATUS AND METHOD FOR MANAGING NETWORK STORAGE

(75) Inventors: LUNG DAI, Tu-Cheng (TW); WANG-CHANG DUAN, Shenzhen City (CN); BANG-SHENG ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu Cheng (TW)

(21) Appl. No.: 12/424,546

(22) Filed: Apr. 16, 2009

(30) Foreign Application Priority Data
Apr. 18, 2008 (CN) 200810301188.8

(51) Int. Cl. G06F 12/00; G06F 13/12; G06F 12/14; G06F 3/048

(52) U.S. Cl. 707/200; 710/74; 711/164; 715/840; 715/700; 711/E12.001; 711/E12.093; 707/E17.01

(57) ABSTRACT

A method for managing a plurality of network storages on a computer device includes: receiving login commands in response to the users' operations; simultaneously transmitting a first access request to get read/write authority with respect to the first network storage, and a second access request to get read/write authority with respect to the second network storage in response to the login commands; receiving and combining first information from the first network storage and second information from the second network storage after the first and the second access requests being authorized by the network storages; displaying the combined information on a single graphical user interface.

### BACKGROUND

1. Technical Field

The present disclosure generally relates to network management, and particularly to an apparatus and method for managing network storages provided by various web sites.

2. Description of Related Art

More and more web sites provide network storage. Users using this type of storage are able to access their information from anywhere using the Internet.

Some websites only provide limited storage space, as a result, a user may use having need for large storage space may employ more than one website for his storage needs. Thus, when the data needs to be accessed, the user will need to login to more than one website. Furthermore, each of the more than one network storages may provide a different user interface which can be frustrating.

Therefore, an apparatus and a method for managing network storages are desired.

Other advantages and novel features will become more apparent from the following detailed description of exemplary embodiments when taken in conjunction with the accompanying drawings.

### BRIEF DESCRIPTION OF THE DRAWINGS

FIG. 1 is a schematic diagram of a network storage system including a network storage managing apparatus in accordance with an exemplary embodiment.

FIG. 2 is a functional block diagram of the computer in FIG. 1.

FIG. 3 is functional block diagram of a file handling application in the FIG. 2 in accordance with an exemplary embodiment.

FIG. 4 is login interface displayed in the computer in accordance with an exemplary embodiment.

FIG. 5 is main interface displayed in the computer in accordance with an exemplary embodiment.

FIG. 6 is setting interface displayed in the computer in accordance with an exemplary embodiment.

FIG. 7 is a flowchart of a method for managing a plurality of network storages in accordance with an exemplary embodiment.

### DETAILED DESCRIPTION

References will now be made to the drawings to describe exemplary embodiments of an apparatus and a method for managing a plurality of network storages.

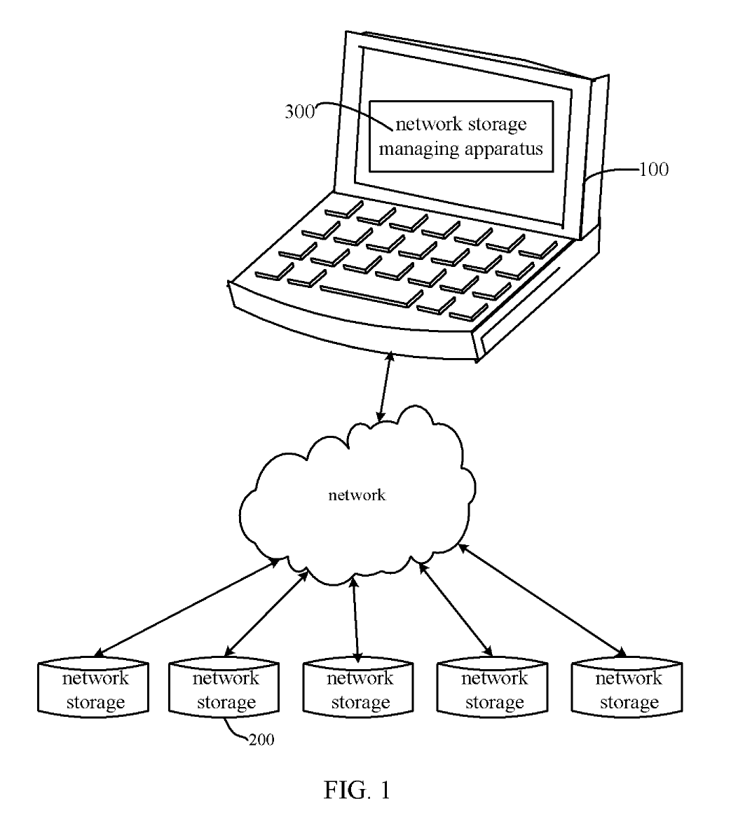

Referring to FIG. 1, a network storage system includes the computer 100 installed with the network storage managing apparatus 300, and a plurality of network storages 200 connectable to the computer 100 via a network. The network storages 200 are used for storing data accessible to the computer 100 via the network. In this embodiment, the network may be an Internet. The network storages 200 may communicate over the internet using different data transfer protocols. For example, the data transport protocols may be Hyper Text Transfer Protocol (HTTP) and file transfer protocol (FTP). The network storage managing apparatus 300 may be a software stored in a storage medium of the computer 100 or a firmware integrated in a chip set of the computer 100. The network storage managing apparatus 300 may be invoked to provide a graphical user interface (GUI) to display information/contents of all the network storages 200 on a display by the computer 100. The information/content distributed across different network storages 200 can be managed using one GUI without having to retrieve these information/contents separately. In this way, managing a plurality of the network storages 200 appears as managing one network storage virtually.

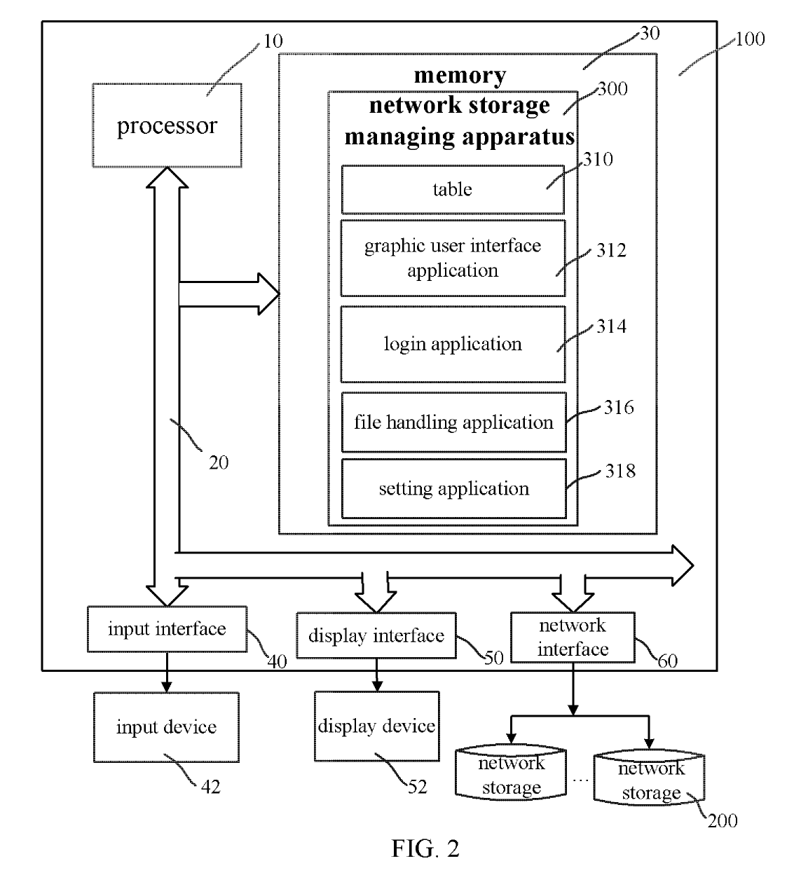

Referring to FIG. 2, the computer 100 includes a processor 10, a memory 30, an input interface 40, a display interface 50, and a network interface 60. These components of the computer 100 are interconnected through a bus 20. The input interface 40 is configured for connecting with an input device 42, such as a mouse or a keyboard. The display interface 50 is configured for connecting with a display device 52, such as a liquid crystal display (LCD) or a cathode-ray tube (CRT). The network interface 60 is connected to a network. The processor 10 invokes programs stored in the memory 30 to control the operation of the computer 100.

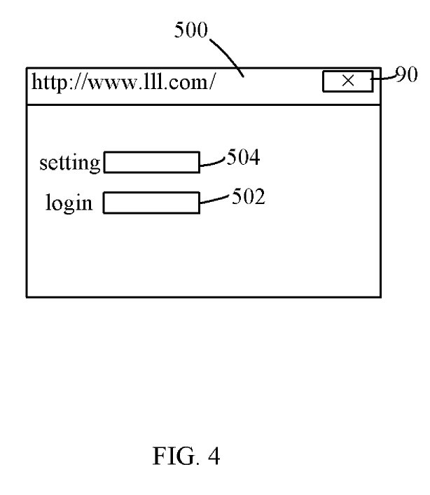

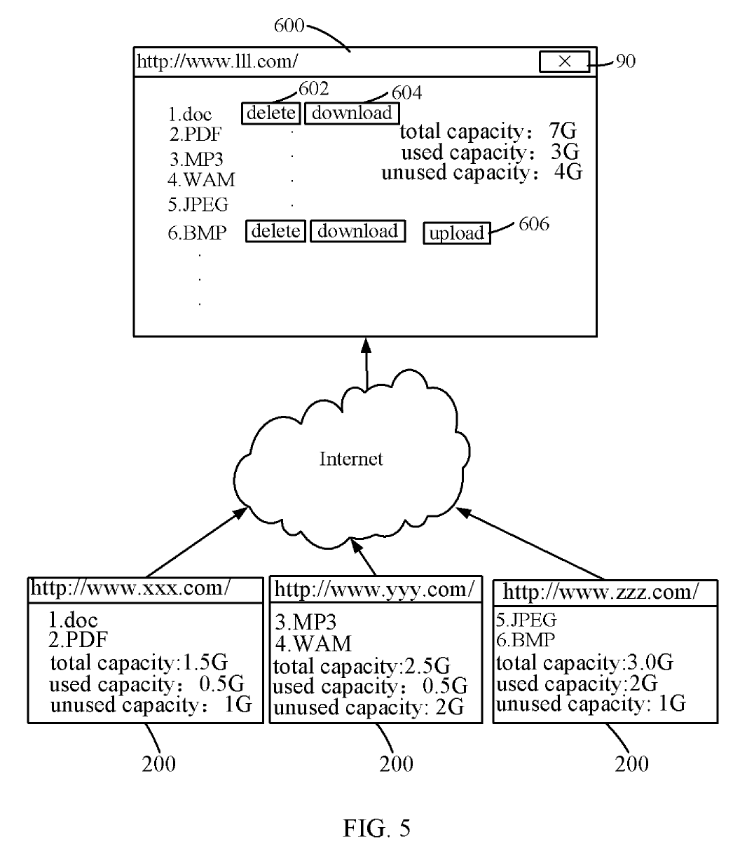

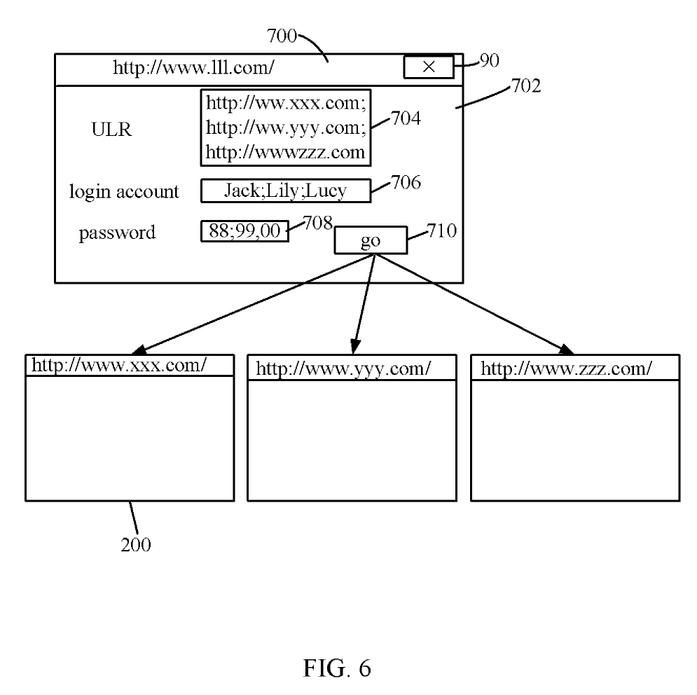

The network storage managing apparatus 300 is stored in the memory 30. The network storage managing apparatus 300 may be a computer application, and includes a graphical user interface (GUI) application 312, a login application 314, a file managing application 316, and a setting application 318. Each of the GUI application 312, the login application 314, the file handling application 316, and the setting application 318 is executed by the processor 10. The GUI application 312 is configured to provide various interfaces on the display 52. The interfaces include, but not limited, a login interface 500 (see FIG. 4), a main interface 600 (see FIG. 5), a setting interface 700 (see FIG. 6). Both the main interface 600 and the setting interface 700 are invokeable at the login interface 500. When the network storage managing apparatus 300 is invoked via the input device 42, the processor 10 invokes the GUI application 312, and then displays the login interface 500 on the display 52.

Referring to FIG. 4, the login interface 500 includes a selectable login button 502, and a selectable setting button 504. When the login button 502 is selected/pressed via the input device 42, the processor 10 invokes the login application 314. When the setting button 504 is selected/pressed via the input device 42, the processor 10 invokes the setting application 318.

The login application 314 is connectable with the network storages 200. A table 310 recording access information of the network storages 200 is stored in the memory 30 and is modifiable. The access information includes a set of location, account name, and account password to each of the network storage 200. When the login application 314 is invoked, the processor 10 automatically accesses the network storages 200 using the access information. The processor 10 then invokes the file handling application 316 to process accessed information from the network storages 200, and display combined information of the network storages 200 on the main interface 600. As a result, the network managing apparatus 310 can display the information of the network storages 200 using a signal GUI interface.

Referring to FIG. 5, in this embodiment, the received information from three network storages 200 are displayed in the main surface 600. Each of the network storages 200 uses HTTP as the data transport protocol. For example, a first network storage 200 has a URL of “http://www.xxx.com” and a capacity of 1.5 G. A second network storage 200 has a URL of “http://www.yyy.com” and a capacity of 2.0 G. A third network storage 200 has a URL of “http://www.zzz.com” and a capacity of 3.0 G. The first network storage 200 may be used to store document files, the second network storage may be used to store media files, and the third network storage 200 may be used to store image files. The total capacity of the one of more network storage 200 and a list of data files on the three network storages 200 are also displayed on the main interface 600. The main interface 600 further includes a plurality of selectable file management buttons. The processor 10 may call the file handling application 316 according to the selectable file management buttons pressed.

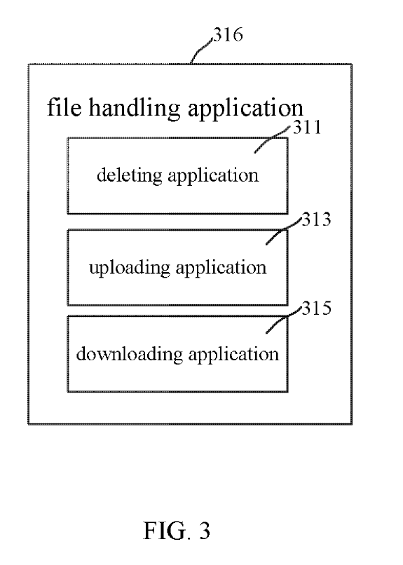

Referring to FIG. 3, in this embodiment, the file handling application 316 further includes a delete application 311, a download application 313, and an upload application 315. Accordingly, the handling buttons includes selectable delete buttons 602, selectable download buttons 604, and upload buttons 606. Each delete buttons 602 or each upload buttons 606 is associated with one file of the network storages 200. The deleting buttons 602 delete a corresponding file from one of the network storages 200 when selected. The downloading buttons 604 download a corresponding file from one of the network storages 200 to the computer 100 when selected. The uploading button 606 uploads a selected file from the computer 100 to one of the network storages 200 when selected. For example, when the uploading button 606 is pressed, the processor 10 calls the uploading application 315 to upload selected files in the computer 100. E.g., when uploading application 315 is called, the processor 10 fetches a corresponding file in the computer 100 and transmits the file and a file uploading request to the corresponding network storage 200, and then the corresponding network storage 200 receives and stores the corresponding file. Likewise, when one of the deleting buttons 602 is pressed, the processor 10 calls the deleting application 311 to delete the selected files from the corresponding network storages 200. E.g., when deleting application 311 is called, the processor 10 transmits a file deleting request to the corresponding network storage 200, and the selected file is removed from the corresponding network storage 200. Likewise, when one of the downloading buttons 604 is pressed, the processor 10 calls the downloading application 313 to download the selected file from the corresponding network storage 200. E.g., when the deleting application 313 is called, the processor 10 transmits a file downloading request to corresponding network storages 200, and then the corresponding processor 10 download the selected file to the computer 100.

Referring FIG. 6, the setting application 318 is executed to set the access information in the table 310. The setting interface 700 includes a user input screen 702 with a (uniform resource locator) location dialog box 704, an account name dialog box 706, and a password dialog box 708 to modify access information associated with the plurality of network storages 200 correspondingly. For example, the location dialog box 704 is filled with URLs, the account name dialog box 706 is filled with account names, the password field 708 is filled with account passwords. A “go” button 710 is provided on the setting interface 700 to invoke the login application 314 based on the access information in the location field 704, the account name field 706, and the password field 708 in the setting interface 700.

Moreover, referring FIGS. 4, 5, and 6, each of the login interface 500, the main interface 600 and the setting interface 700 provides a selectable logoff button 90 selectable using the input device 42. The processor 10 may disconnect from the network storage apparatus 310 when the logoff button is clicked.

As described above, the computer 100 with the network storage managing apparatus 300 is capable of allowing users to manage files distributed in a plurality of network storages on one GUI interface and which the plurality of network storages looks like one network storage, thus, it is very easy for the users to manage files distributed in different network storages.

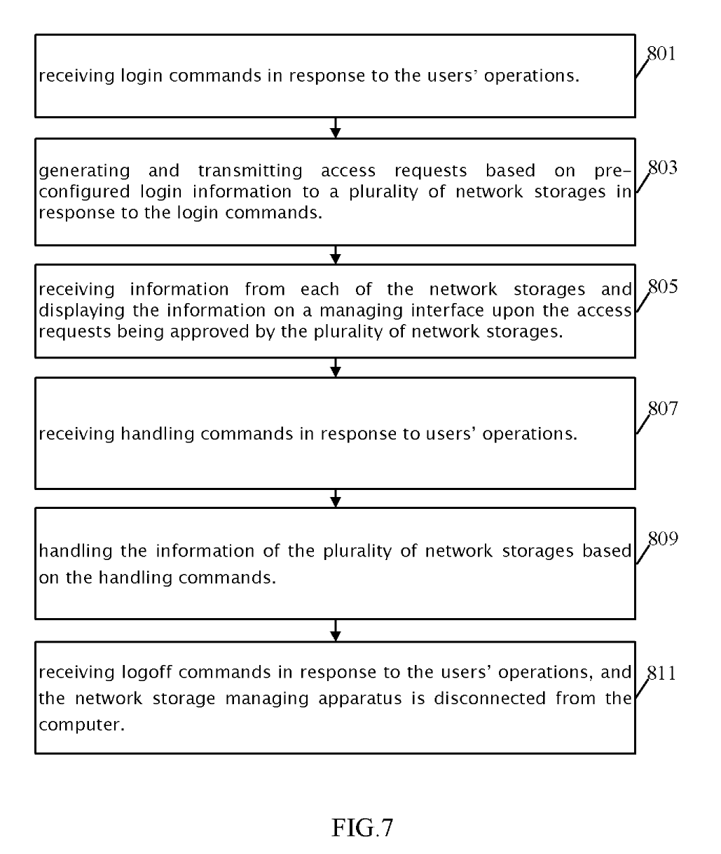

Referring to FIG. 7, a method for managing a plurality of network storages is shown. The method includes the following steps each of which is tied to the components contains in the computer 100 as shown in the FIG. 2 and FIG. 3.

In step 801, receiving login commands in response to the users' operations. For example, the users can use an input device 42 to click an icon of a network storage managing apparatus 300 displayed on the display device 52 to invoked the network storage managing apparatus 300. The GUI application 312 stored in memory 30 is then executed to provide the login interface 500 providing a selectable login button 502 (see FIG. 4). The login commands are inputted when the login button 502 is selected/pressed by the input device 42.

In step 803 generating and transmitting access requests based on pre-configured access information in a table 310 to a plurality of network storages 200 in response to the login commands. The pre-configured access information may include a set of location, account name, and account password associated with the plurality of network storages 200. The table 310 is stored in the memory 30 and is capable of being updated. The users can update the access information via the login interface 500. For example, the login interface 500 further provides a selectable setting button 504. When the setting button 504 is selected/pressed via the input device 42, the GUI application 312 is executed to provide a setting interface 700 (see FIG. 6) to fill access information, and the setting application 318 stored in the memory 30 is executed to set the filled access information in the memory 30.

In step 805, receiving information from the network storages 200 and combining the information received to display on a main interface 600 (see FIG. 5) after the access requests being authorized by the network storages 200. For example, the processor 10 receives the information from each of the network storages 200, invokes the file handling application 316 to combine the information from the network storages 200, and then invokes the GUI application 312 to provide the main interface 600 to display the received information after the access requests being authorized by the plurality of network storages 200.

In step 807, receiving handling commands in response to users' operations. For example, the main interface 600 further provides a plurality of handling buttons, such as, deleting buttons 602 associated with the files respectively, a downloading buttons 604 associated with files respectively, and a uploading button 606. The deleting buttons 602, the downloading buttons 604, and the uploading button 606 enable users to input handling commands.

In step 809, handling the information of the plurality of network storages 200 based on the handling commands. A deleting application 311, a downloading application 313, and an uploading application 315 stored in the memory 30 may be executed to delete, download, upload files from to the network storages 200.

In step 811, receiving logoff commands in response to the users' operations, and the network storage managing apparatus 300 is disconnected from the computer 100. For example, each of the login interface 500, the main interface 700 and the setting interface 700 provides a logoff button 90 to input logoff commands using the input device 42, the processer 10 is disconnected from the network storage managing apparatus 300.

As described above, the network storage managing method for operating the network storage 200 includes actions of displaying the information, such as files distributed in different network storages on one GUI, it is convenient for users to manage.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer comprising:
an input interface capable of connecting with an input device for receiving input signals from an user;
a display interface capable of connecting with a display device for outputting display information to the user;
a processor electrically connected with the input interface, the display interface, the network interface for receiving the input signals from the input interface and outputting the display information to the display interface; and
a memory storing a management apparatus, the management apparatus is executed by the processor for connecting with at least two network storages and displaying information from the at least two network storages by a single graphical user interface (GUI).

2. The computer of claim 1, wherein the management apparatus comprises a table recording access information connected with the at least two network storages.

3. The computer of the claim 2, wherein the access information includes a set of location, account name, and account password associated with each of the at least two network storages respectively.

4. The computer of claim 2, wherein the management apparatus further comprises a setting application, the processor invokes the setting application to set the access information in the table.

5. The computer of the claim 1, wherein the management apparatus further comprises a file handing application, the processor invokes the file handling application to handle information of the at least two network storages to display the information of the at least two network storages in the graphical user interface.

6. The computer of the claim 1, wherein the information of the plurality of the network storages may includes files stored in the at least two network storages and capacity information of the at least two network storages.

7. The computer of the claim 1, wherein the managing apparatus further includes an uploading application, a downloading application, and a deleting application, the processor invokes the uploading application to upload files to a corresponding network storage of the at least two network storages, the processor invokes the downloading application to download files from a corresponding network storage of the at least two network storages, and the processor invokes the deleting application to delete the files from a corresponding the network storage of the at least two network storages.

8. The computer of the claim 1, wherein the management apparatus further comprises a graphic user interface (GUI) application for providing the GUI to the display interface.

9. The computer of the claim 8, wherein the GUI further provides deleting buttons associated with the files respectively, downloading buttons associated with the files respectively, and the uploading button, the deleting buttons, downloading buttons and the uploading button are to input the handling commands, the process executes the uploading application, the downloading application, and the deleting application respectively when interprets the handling commands.

10. A system for network storage management stored in a medium and executed by a computer comprising:
a login application invoked for connecting with at least two network storages;
a handling application invoked to combine the information from the at least two network storages;
a graphical user interface application invoked to provide a single graphical user interface (GUI) to display the combined information.

11. The system of claim 10, wherein the system comprises a table recording access information associated with each of the at least two network storages.

12. The system of the claim 11, wherein the access information includes a set of location, account name, and account password associated with each of the at least two of network storages respectively.

13. The system of the claim IO, wherein the handling apparatus is further invoked to handle information of the at least two network storages to display the handling information in the GUI.

14. The system of the claim 10, wherein the information of the network storages includes files stored in the plurality of the at least two network storages and capacity information of the plurality of the at least two network storages.

15. The system of the claim 14, wherein the handling application is further invoked to upload files to a corresponding network storage of the at least two network storages, download files from a corresponding the network storage, and delete the files from a corresponding network storage of the at least two network storages.

16. The system of the claim 15, wherein the GUI further provides deleting buttons associated with the files respectively, downloading buttons associated with the files respectively, and the uploading button, the deleting buttons, downloading buttons and the uploading button are to input the handling commands, the process invokes the uploading application, the downloading application, and the deleting application respectively when interprets the handling commands.

17. A method comprising:
receiving login commands in response to the users' operations;
simultaneously transmitting a first access request to get read/write authority with respect to a first network storage, and a second access request to get read/write authority with respect to a second network storage in response to the login commands;
receiving and combining first information from the first network storage and second information from the second network storage after the first and the second access requests being authorized by the network storages;
displaying the combined information on a single graphical user interface (GUI).

18. The method of claim 17, wherein the first access request corresponding to the first network storage and the second access request corresponding to the second network storage are generated based on first access information and second access information pre-configured in the computer device.

19. The method of claim 18, wherein the pre-configured access information includes a set of location, account name, and account password associated with each of the first network storage and the second storage.

20. The method of claim 17, wherein the method further comprise:
receiving handling commands in response to the users' operations;
handling the information displayed in the GUI.
